(19) United States
(12) Patent Application Publication
(10) Pub. No.: US 2007/0131841 A1
(43) Pub. Date: Jun. 14, 2007

(54) Archery bow limb compression mold and method for manufacturing archery bow limbs

(76) Inventor: Henry M. Gallops JR., Gainesville, FL (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/301,152

(22) Filed: Dec. 12, 2005

(51) Int. Cl. A01J 25/13; B27N 3/08

(52) U.S. Cl. 249/117; 264/239

(57) ABSTRACT

A preferred embodiment of the present invention includes a compression mold for forming an archery bow limb. The compression mold comprises a mold assembly defining a mold cavity for receiving a resin and fiber slug. The mold cavity defines a limb tip area with outer limb tip portions. The mold assembly defines the mold cavity in the shape of an archery bow limb. The mold assembly further comprises a protrusion formed in the mold cavity. The protrusion includes a crown configured to urge glass fibers in the slug into the outer limb tip portions. The protrusion forms a depression to be ground to form a limb tip slot in the archery bow limb. In preferred embodiments, the protrusion includes a middle tapered area having a summit. In preferred embodiments, the outer limb tip portions have a higher glass fiber density than a remainder of the archery bow limb.

### FIELD OF THE INVENTION

The present invention relates generally to archery bows and more particularly pertains to an archery bow limb, an archery bow limb compression mold and methods for manufacturing archery bow limbs.

### BACKGROUND OF THE INVENTION

Archery bow limbs perform the important function of storing energy when the archer draws the bowstring. When the bowstring is drawn, the pre-stressed bow limbs, which are typically made of resilient material, are further flexed to store additional energy. When the bowstring is released, the stored energy propels the arrow. In conventional compound bows, the limb is typically formed of a single element with a substantially rectangular cross section, where one end is attached to the bow handle and the other end has a limb tip slot formed therein, in which a rotational member such as a wheel, cam or pulley is mounted.

Reinforced glass fiber materials have been utilized in archery bow limbs for a number of years. In some instances, the limb profile is machined from extruded solid glass fiber billets, and in other instances the limb profile is machined from pre-formed compression molded billets, which in some cases may be pre-formed to such near net shape that only secondary machining operations are required to remove excess material from the limb tip area and from the butt section, where the limb is joined to the handle. The machining operations can result in the severing of load bearing fibers which reduces the maximum limb operating stress level and the fatigue life of the limbs. In particular, machining out the limb tip slot can sever numerous fibers.

### SUMMARY OF THE INVENTION

In certain preferred embodiments, the present invention is concerned with an archery bow limb compression mold assembly, a method for manufacturing compression molded archery bow limbs using the mold assembly, and the archery bow limbs produced thereby.

In a preferred embodiment of the present invention, a compression mold for forming an archery bow limb includes a mold assembly defining a mold cavity. The mold cavity receives a resin and fiber slug and is defined in the shape of an archery bow limb. The mold cavity defines a limb tip area with outer limb tip portions. The mold assembly includes a protrusion formed in the mold cavity. The protrusion preferably has a crown and is configured to urge glass fibers in the slug into outer limb tip portions in the archery bow limb.

In another preferred embodiment of the present invention, a mold for forming an archery bow limb comprises a mold assembly defining a mold cavity. The mold cavity receives a slug including resin and glass fibers. The mold assembly defines the mold cavity in the shape of an archery bow limb. The mold further includes means for urging the glass fibers into outer limb tip portions at a distal tip of an archery bow limb.

In yet another preferred embodiment of the present invention, a method of manufacturing an archery limb for an archery bow comprises placing a moldable slug in a compression mold assembly defining an archery bow limb profile. The moldable slug preferably includes a plurality of longitudinally oriented glass fibers and resin. The mold assembly preferably urges the glass fibers in an area defining a limb tip into outer limb tip sections. The method further includes compressing the slug into the mold assembly to form the shape of an archery bow limb with separated fibers and curing the glass fiber slug.

It is an object of this invention to provide an archery bow limb mold configuration, methods of manufacturing compression molded archery bow limbs, and to provide archery bow limbs.

Other objects and attendant advantages of this invention will be readily appreciated as the same become more clearly understood by references to the following detailed description when considered in connection with the accompanying drawings.

### BRIEF DESCRIPTION OF THE DRAWINGS

FIG. 1 is a perspective view of a compound archery bow.

FIG. 2 is a perspective view of a bow limb according to an embodiment of the present invention.

FIG. 3 is a top view of a slug frame with impregnated filaments wrapped thereon.

FIG. 4A is a perspective side elevation view of a mold assembly according to a preferred embodiment of the present invention.

FIG. 4B is a perspective, top view of the lower mold.

FIG. 4C is a perspective side elevation view of a prior art mold assembly.

FIG. 5 is a perspective side elevation view of the mold assembly during curing.

FIG. 6 is a cross-sectional view of the lower mold taken approximately along line 6-6 of FIG. 5 viewed in the direction of the arrows.

FIG. 7 is a cross-sectional view of the lower mold taken approximately along line 7-7 of FIG. 5 viewed in the direction of the arrows.

FIG. 8 is a perspective view of part of a bow limb according to a preferred embodiment of the present invention.

FIGS. 9-12 are cross-sectional views of alternative lower molds according to alternative embodiments of the present invention.

### DETAILED DESCRIPTION OF PREFERRED EMBODIMENTS

For the purposes of promoting an understanding of the principles of the invention, reference will now be made to the embodiments illustrated and specific language will be used to describe the same. It will nevertheless be understood that no limitation of the scope of the invention is thereby intended, such alterations, modifications, and further applications of the principles of the invention being contemplated as would normally occur to one skilled in the art to which the invention relates.

In preferred embodiments, a compression mold for forming an archery bow limb comprises a mold assembly. The mold assembly defines a mold cavity, in the shape of an archery bow limb, for receiving a resin and fiber slug. The mold cavity defines a limb tip area with outer limb tip sections. The mold assembly further comprises a protrusion formed in the mold cavity. The protrusion preferably urges the fibers in the slug in the limb tip area into the outer limb tip sections. The protrusion defines a depression in the rough limb which can be ground to form a limb tip slot in the archery bow limb.

A method according to the present invention forms a limb for use in an archery bow. A preferred method comprises inserting a moldable slug including resin and a plurality of longitudinally oriented fibers into a bow limb profiling mold. A typical mold consists of two halves, a first half containing one or more female cavities and a second half having one or more mating male sections. In preferred embodiments of the present invention, the first half of the mold cavity includes a protrusion to form a depression in the limb and urge the fibers in that portion toward outer sections of the mold cavity. Heat and pressure are applied for initial curing. The limb is then removed from the mold, flashed and post-cured. The depression is ground to form a slot in the bow limb tip.

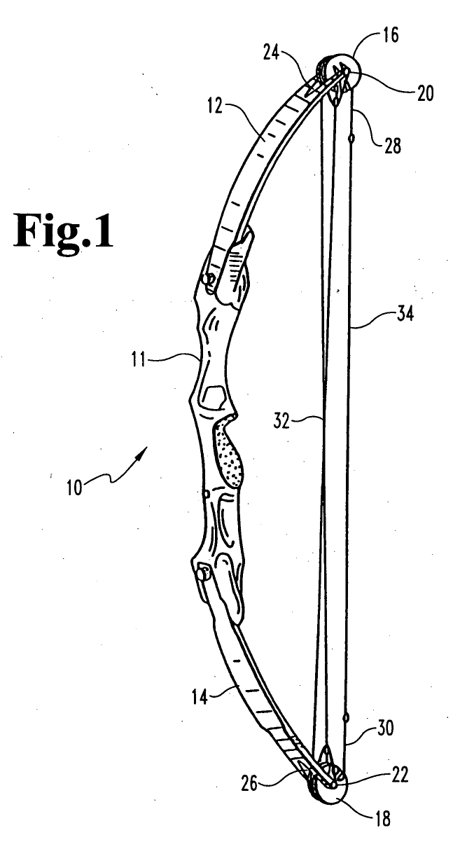

FIG. 1 illustrates one example of a conventional dual-cam compound archery bow generally designated as 10. When viewed from the perspective of an archer holding the bow 10, it includes a handle or riser 11 with an upper limb portion 12 and a lower limb portion 14. Centrally disposed rotational members forming variable leverage units such as eccentric pulleys 16 and 18 are supported at the limb tip sections for rotary movement about axles 20 and 22. In the embodiment shown, the upper pulley axle 20 is carried in a slot between the outer limb tip portions 24 of upper limb 12. The lower pulley axle 22 is carried in a slot between the outer limb tip portions 26 of lower limb 14.

Bowstring 34 includes upper end 28 and lower end 30 which are fed-out from pulleys 16 and 18 when the bow is drawn. Bowstring 34 is mounted around pulleys 16 and 18 as is known in the art. Anchor cable 32 preferably extends from an eccentric pulley on one limb, for example axle 20, to the extremities of the opposing bow limb, for example axle 22. The opposed upper bow limb 12 and lower bow limb 14 are relatively short and will characteristically have high spring rates.

When the bowstring 34 is drawn, it causes eccentric pulleys 16 and 18 at each end of the bow to rotate, feeding out cable and bending limb portions 12 and 14 inward, causing additional energy to be stored therein. When the bowstring 34 is released with an arrow engaged to the bowstring, the limb portions 12 and 14 return to their rest position, causing the eccentric pulleys 16 and 18 to rotate in the opposite direction, to take up the bowstring 34 and launch the arrow with an amount of energy proportional to the energy initially stored in the bow limbs. Bow 10 is described for illustration and context and is not intended to be limiting. The present invention can be used with dual-cam compound bows, or can be used with single-cam bows as described for example in U.S. Pat. No. 5,368,006 to McPherson, hereby incorporated herein by reference, or can be used in other pulley/cam arrangements. The present invention can also be used in other types of bows, which are considered conventional for purposes of the present invention.

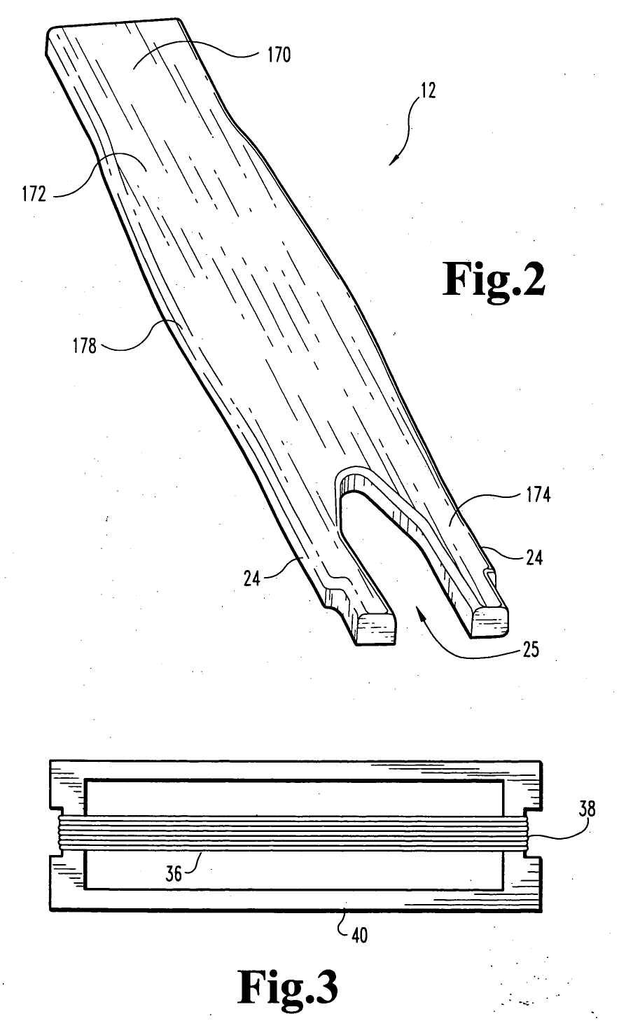

Illustrated in FIG. 2 is a perspective view of limb portion 12 according to one embodiment of the invention. Limb portion 14 is symmetric to limb portion 12, and, although included in the present invention, will not be described in duplicate detail. In certain preferred embodiments, limb portion 12 includes a butt section 170, a hinge section 172 and a tip section 174, with radiused side edges 178. Tip section 174 includes two outer limb tip portions 24 defining a slot 25.

Referring to FIG. 3, there is illustrated, for example, a glass fiber slug 36 from which a bow limb portion such as portions 12 and 14 of the instant invention can be fabricated. Glass fiber filaments 38, which form the glass fiber slug 36, are initially drawn through a wet out tank containing a suitable resin. After absorbing the desired amount of resin, the glass fiber filaments 38 are wrapped around a frame 40. Each wrap consists of one complete turn or loop around frame 40. A plurality of wraps are necessary to form each limb and therefore each slug 36 consists of a number of individual wraps.

Both the glass fiber and the resins used in this process are well known in the art. In certain preferred embodiments, the resin is a suitable plastic resin matrix material. Suitable materials include glass fiber filaments which are packaged in spools and sold by Pittsburgh Plate Glass Corp. under the designation No. 712-218, to be employed with Shell 826 epoxy resin and a suitable heat activated catalyst such as Lindride 6K manufactured by Lindow Chemical Company. It has been found that the range of suitable glass fiber to resin ratios by weight is from 60% to 75% which is the equivalent of a glass fiber to resin ratio by volume in the range of 42% to 59%.

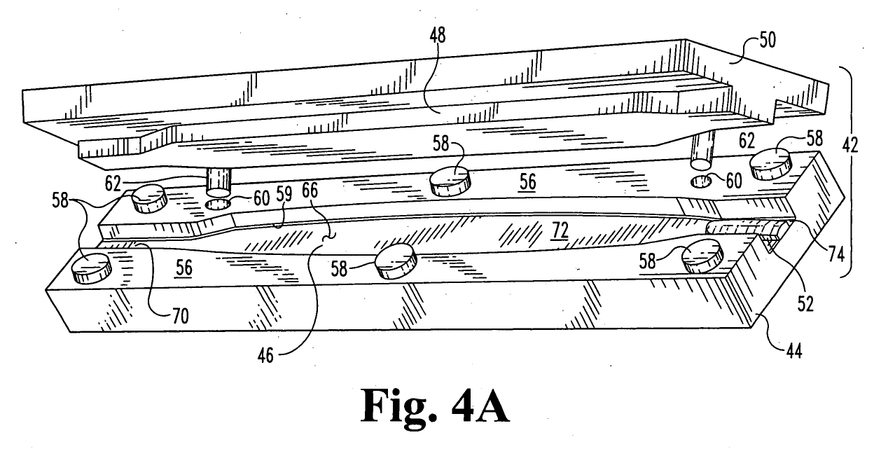

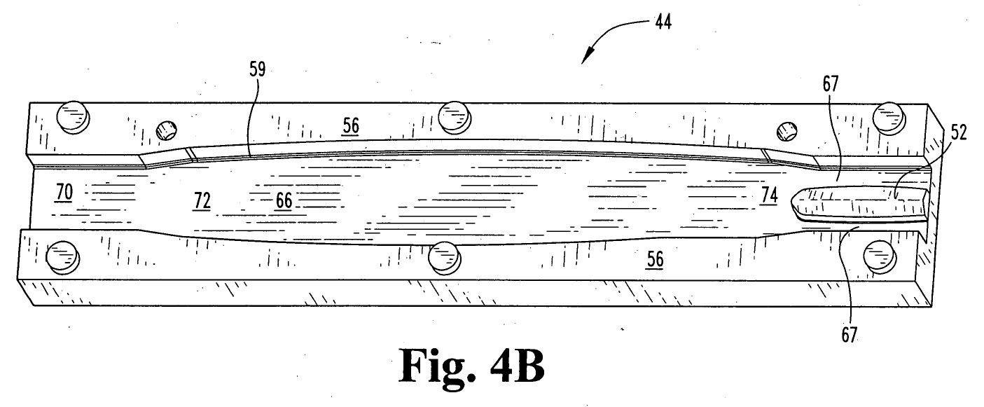

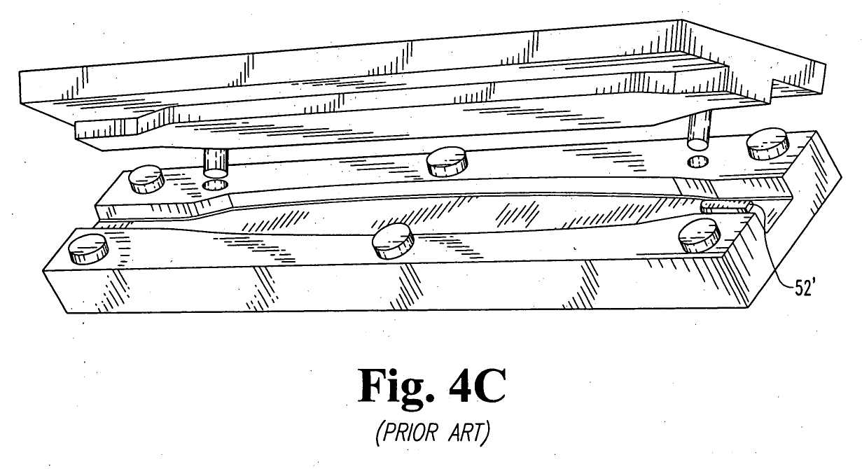

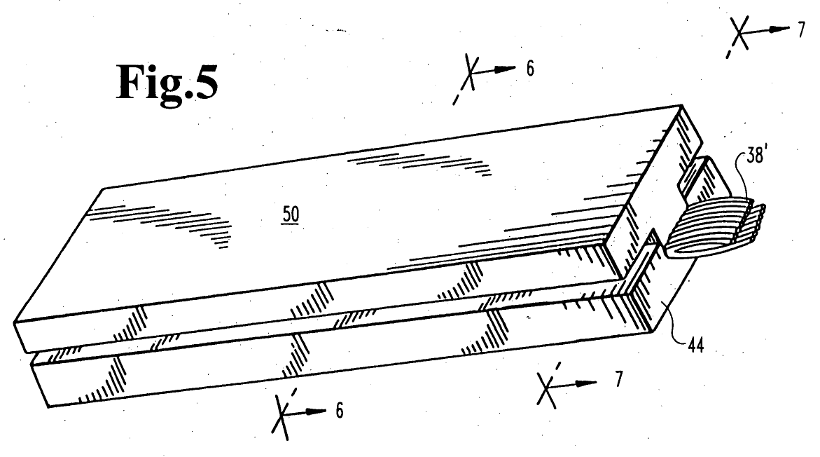

When slug 36 is in suitable condition to be molded, it is inserted into the mold assembly 42 illustrated in FIGS. 4A and 4B. The frame 40 is positioned so that the slug 36 extends longitudinally within a female cavity 46 defined in lower mold 44 and the glass fiber filaments 38 extend out of the assembly 42 in the form of a tail 38′ (see FIG. 5). Female cavity 46 is defined between sidewalls 56 and floor 66. Preferably, the female cavity 46 forms radiused lower corners 59. The cavity 46 of the lower mold 44 in conjunction with the mating male member 48 of upper mold 50 is shaped to form the slug 36 into a limb portion. Preferably the male member presses the slug into the cavity, and preferably the mold assembly 42 compresses the slug. In the embodiment shown, the floor 66 of female cavity 46 forms the front of the limb portion, while the face of male member 48 forms the rear of the limb portion. In a preferred feature, stops 58 limit the penetration of male mold member 48 into the female mold cavity 46, and openings 60 in lower mold 44 receive alignment pins 62 of upper mold 50 when the mold is closed.

Preferably the mold cavity defines a butt section 70 for a limb, a hinge section 72 for a limb, and a tip section 74 for a limb. In one option (not shown), the mold defines a split area in the butt section to enable the limb to be attached to a bolt on a bow riser. In preferred embodiments, tip section 74 includes a protrusion 52 having a crown and defining a partial height raised or split area to form a depression or reduced height limb tip portion which can be ground down to form slot 25 for a pulley to be mounted.

Protrusion 52 preferably includes an apex or summit area 65 rising to a peak or upper portion. In some embodiments, the apex or summit area is a rounded segment. In certain other embodiments, the protrusion includes a plurality of straight, tapered segments. Additionally, the protrusion can include a combination of rounded segments and straight segments together defining a tapered height of the protrusion. The protrusion preferably runs longitudinally for a portion of the length of the mold cavity. In certain preferred embodiments, the protrusion includes a length corresponding to a desired slot depth in the archery bow limb tip.

The protrusion divides the cavity at tip section 74, leaving two outer limb tip sections 67 of cavity 46. The two outer limb tip sections of the cavity will define the two outer limb tip portions of limb tip section 174.

Using the prior art mold illustrated in FIG. 4C having a protrusion 52′ with a flat top surface, glass fibers filaments in the central area were not separated and thus numerous fibers were severed during the grinding process. To improve the limb strength and lifespan, the protrusion having a crown, preferably urges the fibers in the depression area toward the outer limb tip portions. As a result, the fiber filaments in the outer limb tip portions are uncut, continuous and protectively sealed in the typically stressed limb tip areas. Reducing the number of glass fibers severed during machining of the archery bow, and specifically during machining of the limb tip slot increases the limb strength and lifespan. Urging the glass fibers into outer limb tip portions of the archery bow limb preferably reduces the amount of glass fibers present in the depression area, and thus reduces the number of fibers severed when the depression area is later ground to form the limb tip slot.

In preferred embodiments, the protrusion separates and urges a substantial majority of the glass fibers in the slug from the middle width area toward the two side or fork sections of the cavity, packing the glass fibers into the outer limb tip portions. This may occur during the compression step. Separating and urging of the glass fibers may also occur when the slug is placed in the mold cavity. It should be appreciated that, in certain embodiments, a minimal amount of glass fibers will remain in the depression and may be severed during machining of the limb tip slot.

In an alternative embodiment, at least one half of the mold, preferably the female cavity 5 section, is formed with a rib cavity (not shown) to define a rib portion in the hinge section of the limb. A limb formed with such a mold would integrally include the rib portion. In such embodiments, the rib portion of the limb increases the sectional modulus of the limb, i.e., the limb's spine or stiffness is increased. This also allows thinner limb tips, reducing the amount of mass moved as the limbs recoil from a drawn to brace position. The lower mass in the tips also 10 reduces the moment of inertia, enabling the limbs to react more quickly and at a higher frequency resulting in higher arrow velocity.

In manufacturing the limb, the initial curing of the slug 36 occurs when slug 36 is inserted and compressed into the mold assembly 42 which has been heated to an operating temperature of approximately 300 degrees to 350 degrees Fahrenheit. Slug 36 is preferably maintained in the closed mold assembly 42 at this temperature for a period of 5 to 10 minutes, whereby slug 36 is set to assume the profile determined by the mold assembly 42. Slug 36 is then removed from the mold assembly 42 and the uncured glass fiber filaments forming the tail 38′ are severed (see FIG. 5). The slug 36 is then cured by being placed in an oven at approximately 350 degrees Fahrenheit for a period of about three hours. Slot 25 is then 20 machined into limb portion 12 for the purpose of receiving an axle pin and pulley.

In a preferred feature, side edges 178 of the formed limb 12 are molded with a radius along their length by radiused lower corners 59 in lower mold 44. This is provided to avoid having to machine grind or cut stress-inducing sharp corners. By molding in this radius, the fiber filaments are uncut, continuous and protectively sealed in the typically stressed comer areas.

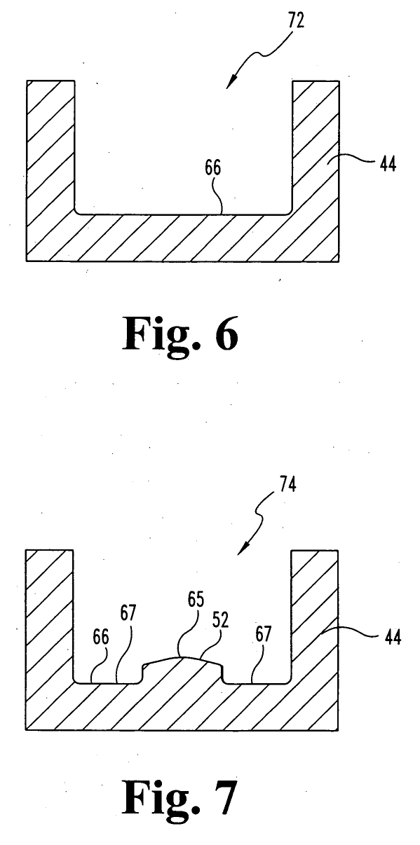

In certain preferred embodiments, the butt 170, hinge 172 and tip 174 sections of limb 12 all have a constant cross-sectional total area. Preferably the cross-sections of the mold are formed in calculated dimensions to maintain a substantially constant cross-sectional area along the length of the mold and in resulting limbs. A cross-section of the mold's hinge section 72 is shown in FIG. 6 and a cross-section of the mold's tip section 74 is shown in FIG. 7.

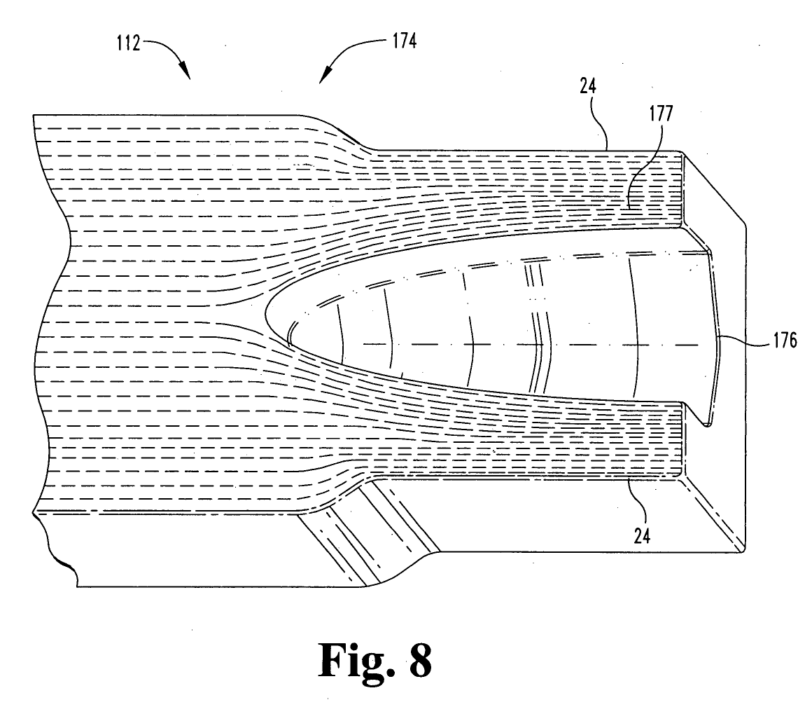

As illustrated in FIG. 7, protrusion 52 includes a middle apex or summit area 65 which may be peaked and/or include one or more tapered sections. Area 65 is preferably configured to urge glass fibers in the slug toward the two outer limb tip sections 67 of the mold cavity when placed in the mold and when compressed. Referring to FIG. 8, there is shown tip section 174 of limb 12 after molding and curing, yet before machining of the depression area to form the limb tip slot. The protrusion in the mold cavity forms a depression 176 in the limb tip section. Depression 176 can be ground to create slot 25. As illustrated schematically by dotted lines, preferably substantially all of the longitudinally oriented glass fibers 177 at the tip are packed into the two outer limb tip portions 24. It should be understood that only example glass fibers 177 are illustrated and only one glass fiber 177 is designated by a reference numeral in FIG. 8, to preserve clarity.

In certain preferred embodiments, the tapered apex or summit area of the protrusion is formed in the mold to disperse the glass fibers. The protrusion is preferably configured to divide the fibers along a centerline of the mold cavity at the tip section and urge the fibers away from the centerline, thereby guiding the fibers towards the outer portions of the mold cavity, such as the two outer limb tip sections. As illustrated in FIG. 8, preferably substantially all or at least a substantial majority of the glass fibers are urged into the two outer limb tip portions of the archery bow limb. Longitudinal glass fibers extending the length of the archery bow limb are desired. Severing the glass fibers during machining of the archery bow limb, such as in the depression area which is ground to form the limb tip slot, can weaken the archery bow limb. In preferred embodiments, a substantial majority of the glass fibers that are separated and urged into the two outer limb tip sections are not cut or severed during the remainder of the bow limb manufacturing process. In certain preferred embodiments, use of the mold cavity having the protrusion, by the method described above, produces archery bow limbs having longitudinal fibers packed into the outer limb tip portions.

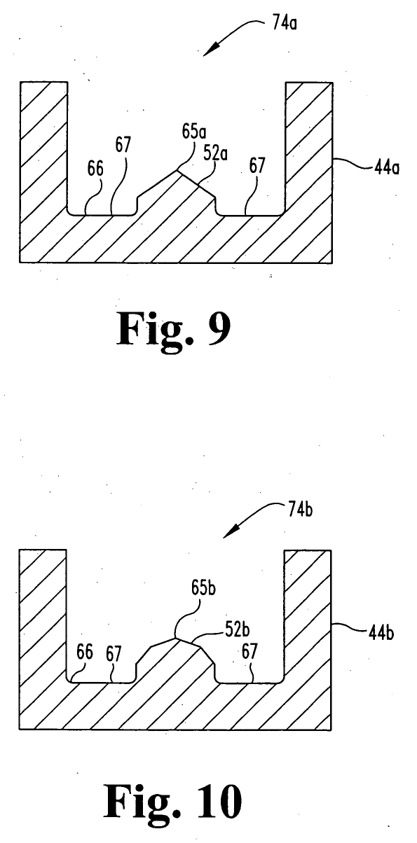

FIGS. 9-12 illustrate cross-sections at tip sections of alternative lower molds having alternative protrusions. FIG. 9 illustrates a cross-section at a tip section 74a of an alternative lower mold 44a. Lower mold 44a includes a protrusion 52a having an apex 65a. As illustrated in FIG. 9, protrusion 52a includes two straight segments which come together to form a peak at apex 65a. FIG. 10 illustrates a cross-section at a tip section 74b of an alternative lower mold 44b having a protrusion 52b. As illustrated in FIG. 10, protrusion 52b includes a plurality straight segments which come together to form a peak at an apex 65b.

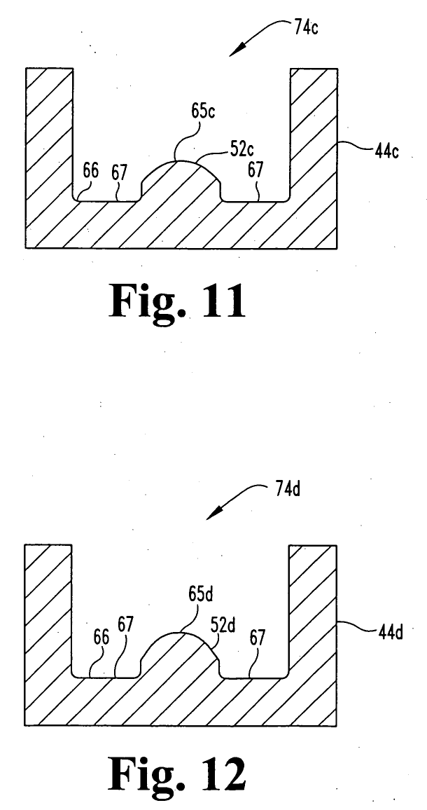

FIG. 11 illustrates a cross-section at a tip section 74c of an alternative lower mold 44c. Lower mold 44c includes a protrusion 52c having a summit area 65c. Summit area 65c includes at least one rounded upper segment. FIG. 12 illustrates a cross-section at a tip section 74d of an alternative lower mold 44d having a protrusion 52d. In the illustrated embodiment, protrusion 52d includes two straight segments joined by at least one rounded upper segment to form summit area 65d. Protrusions 52a-d are arranged in the limb tip section of the mold and are configured to urge glass fibers in a slug toward the two outer limb tip sections 67 of the mold cavity when placed in the mold and during the compression stage.

In preferred embodiments, the glass fibers are urged into the two outer limb tip sections of the mold cavity, thereby creating an increased fiber density in the outer limb tip portions as compared to the remainder of the bow limb. In some embodiments, the glass-to-resin ratio is constant in all areas of the limb except for the tip section, where a higher glass-to-resin ratio occurs. A certain amount of resin is necessary in the glass-to-resin ratio, as is known in the art, to make certain that the slug forms into a bow limb as desired. The ratio is preferably calculated before the mold process begins to ensure that the required amount of resin remains in the two outer limb tip sections of the mold cavity.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A compression mold for forming an archery bow limb, comprising:
a mold assembly defining a mold cavity for receiving a resin and fiber slug, wherein the mold assembly defines the mold cavity in the shape of an archery bow limb, wherein said mold cavity defines a limb tip area with outer limb tip portions; and,
a protrusion formed in the mold cavity, the protrusion having a crown, wherein said crown is configured to urge glass fibers in the slug into said outer limb tip portions.

2. The mold of claim 1, wherein said protrusion in said limb tip area forms a depression in a resulting archery bow limb arranged to be ground to define a limb tip slot.

3. The mold of claim 1, wherein said protrusion is longitudinally aligned with the length of the mold cavity.

4. The mold of claim 1, wherein said protrusion includes a top surface having a middle portion and two side portions, the middle portion protrusion height being higher than the height of said two side portions.

5. The mold of claim 4, wherein said side portions define one or more tapered portions longitudinally aligned with the length of the mold cavity, wherein said tapered portions are tapered downward in height toward said outer limb tip portions of said mold cavity.

6. The mold of claim 5, wherein said middle portion defines a peak.

7. The mold of claim 1, wherein said protrusion includes an apex, the apex having a higher protrusion height than the sides of said protrusion.

8. A method for manufacturing an archery limb for an archery bow using the mold of claim 1, comprising the steps of:
forming a slug suitable to be molded, the slug including a plurality of longitudinally oriented glass fibers and resin;
placing the slug in the mold of claim 1;
compressing the slug into the mold of claim 1 to form the shape of an archery bow limb;
curing the slug; and,
removing material in a depression formed by said protrusion to form a limb tip slot in the archery bow limb.

9. A mold for forming an archery bow limb, comprising:
a mold assembly defining a mold cavity for receiving a resin and glass fiber slug, the mold assembly defining the mold cavity in the shape of an archery bow limb; and,
means for urging the glass fibers into outer limb tip portions of the mold cavity to be formed into outer limb tip portions at a distal tip of an archery bow limb.

10. The mold of claim 9, wherein the means for urging forms a depression at the distal tip of the archery bow limb to be machined to define a limb tip slot in the archery bow limb.

11. The mold of claim 9, wherein two outer limb tip portions at the distal tip of the archery bow limb are separated by a region of reduced fiber density.

12. The mold of claim 9, wherein each outer limb tip portion at the distal tip of the archery bow limb includes a higher glass fiber density than a remainder of the archery bow limb.

13. The mold of claim 9, wherein the means for urging is a protrusion.

14. The mold of claim 13, wherein said protrusion includes one or more tapered sections and a summit, said tapered sections being tapered downward in height toward the outer limb tip portions of the mold cavity.

15. A method for manufacturing an archery limb for an archery bow using the mold of claim 9, comprising the steps of:
forming a slug suitable to be molded, the slug including a plurality of longitudinally oriented glass fibers and resin;
placing the slug in the mold of claim 9;
compressing the slug into the mold of claim 9 to form the shape of an archery bow limb;
curing the slug; and, removing material to form a limb tip slot in the archery bow limb.

16. A method of manufacturing an archery limb for an archery bow, comprising:
placing a moldable slug in a compression mold assembly defining an archery bow limb profile, the moldable slug including a plurality of longitudinally oriented glass fibers and resin;
wherein the mold assembly urges the glass fibers in an area defining a limb tip into outer limb tip sections;
compressing the slug into the mold assembly to form the shape of an archery bow limb; and,
curing the glass fiber slug.

17. The method of claim 16, wherein said urging includes separating the substantial majority of fibers in said limb tip area into said outer limp tip sections.

18. The method of claim 17, comprising forming a depression in said archery bow limb, wherein said depression separates said limb tip sections.

19. The method of claim 18, comprising removing material between said limb tip sections to form a slot.
